(19) United States
(12) Patent Application Publication
(10) Pub. No.: US 2014/0195115 A1
(43) Pub. Date: Jul. 10, 2014

(54) METHOD FOR CONTROLLING A VERTICAL CONTROL SYSTEM OF A VEHICLE

(71) Applicant: Audi AG, Ingolstadt (DE)

(72) Inventors: Rolf Müller, Darmstadt (DE); Jens Kaltofen, Pfaffenhofen (DE); Tilo Koch, Ingolstadt (DE); Paul Milbredt, Ingolstadt (DE)

(73) Assignee: Audi AG, Ingolstadt (DE)

(21) Appl. No.: 14/151,475

(22) Filed: Jan. 9, 2014

(30) Foreign Application Priority Data
Jan. 10, 2013 (DE) 10 2013 000 360.1

(51) Int. Cl. B60G 21/00

(52) U.S. Cl. CPC B60G 21/00
USPC 701/37

(57) ABSTRACT

A method for controlling a vertical control system of a vehicle with at least two vertical control devices that influence the driving stability of the vehicle, includes monitoring the functionality of the at least two vertical control devices, detecting a fault condition of a first vertical control device of the at least two vertical control devices, and adjusting the control parameters of at least a second vertical control device of the at least two vertical control devices for at least partially compensating of the fault condition of the first vertical control device.

### CROSS-REFERENCES TO RELATED APPLICATIONS

This application claims the priority of German Patent Application, 10 2013 000 360.1, filed Jan. 10, 2013, pursuant to 35 U.S.C. 119(a)-(d), the content of which is incorporated herein by reference in its entirety as if fully set forth herein.

### BACKGROUND OF THE INVENTION

The present invention relates to a method for controlling a vertical control system of a vehicle, and a compensating device for controlling a vertical control system of a vehicle.

The following discussion of related art is provided to assist the reader in understanding the advantages of the invention, and is not to be construed as an admission that this related art is prior art to this invention.

It is known to equip vehicles with vertical control systems in order to variably adjust the driving stability and the driving dynamics. Vertical control systems include a variety of individual vertical control devices, which are known, for example, as air suspension control devices, damping control devices, level control devices or adjustable roll stabilization. Modern vehicles often employ two or even more of such vertical control devices which are combined in a vertical control system

Although fault conditions of conventional vertical control systems can be monitored, the driving stability of the vehicle is disadvantageously severely impaired when a fault conditions is detected. In the worst case, this leads to a break-down of the vehicle, so that the defective vehicle must be towed to the next repair shop by a tow truck. This may already occur when only a single vertical control device is faulty. Accordingly, the complex vertical control systems having a variety of vertical control devices are significantly more error-prone, since a single fault condition can already cause a risk of the vehicle breaking down. This significantly reduces the acceptance among users and also increases the traffic risk, because vehicles that have broken down can impede the traffic flow and endanger the users of the vehicle.

It would therefore be desirable and advantageous to at least partially overcome the aforedescribed disadvantages by allowing the vehicle to continue its travel in the event of failure in a cost-effective and simple manner.

### SUMMARY OF THE INVENTION

According to one aspect of the present invention, a method for controlling a vertical control system of a vehicle with at least two vertical control devices which influence the driving stability of the vehicle includes the following steps:
Monitoring the functionality of the at least two vertical control devices,
Detecting a fault condition of a first vertical control device of the at least two vertical control devices,
Adjusting the control parameters of at least a second vertical control device of the at least two vertical control devices for at least partially compensating the fault condition of the first vertical control device.

The method according to the invention may be referred to as “neighborhood help.” Thus, compensation or partial compensation can here take place within the vertical control system. The fault condition of a single part of a vertical control system, namely, the fault condition of a vertical control device, can thus be compensated or at least partially compensated by adjusting other vertical control devices.

Advantageously, a break-down of the vehicle can thus frequently be avoided compared to conventional control systems. For example, when the fault condition is detected at a first vertical control device, the effect of this fault can be compensated by adjusting the control parameters of one or more other vertical control devices. This compensation can restore the full functionality of the vehicle or at least provide emergency driving conditions. The risk of a break-down can thus be significantly reduced. Likewise, the acceptance by the driver for highly complex vertical control systems is increased in this way. The fault tolerance of such compensation option according to the present invention is accordingly significantly increased.

A vertical control device, which affects the stability of the vehicle, is particularly designed for the suspension and the contact with the road. Therefore, it particularly involves active roll stabilization, air-spring suspensions and other adjustable or controllable spring systems, damper controls or level controls of a vehicle. It will be understood that the individual vertical control devices can also be combined in part by actually combining the components in a vehicle. This is for example the case with an air suspension that can at the same time provide the level control of the vehicle.

Of course, in the method according to the invention, the occurrence of a fault condition, the type of the fault condition and/or the affected vertical control device can be displayed as a warning signal. The driver of the vehicle can hereby be warned of the expected impairment. He can also continue driving while adapting to the type of compensation. This enhances the safety when the method according to the invention is used during the operation of a vehicle.

The individual vertical control devices are preferably monitored by using existing sensor devices of the respective control unit of the relevant vertical control device. Since each of the individual vertical control devices has a dedicated control unit with suitable sensor units for providing a control loop, the available wealth of information can then also be used for the method according to the invention. However, the individual sensor data of vertical control systems encompassing more than one device can also be interpreted more broadly or differently, Accordingly, the method according to the invention can hence be used also with already existing vertical control systems, especially when relying on already existing sensor systems and control units of the vertical control device.

Possible fault conditions of vertical control devices depend on the respective designs of vertical control devices. Thus, for example, a pressure drop in a level control may represent a fault condition. This causes the vehicle to drop to the lowest level at least over a longer operating time, e.g. when the compressor fails or leaks. In such a case, there would be a risk of the damper device and/or the air springs to bottom out. Other fault conditions are defective valves, failures and leaks of additional volumes, or the like.

With the method according to the invention, two or even more fault conditions may still be compensated. This is possible in particular with vertical control systems having two, three or even more vertical control devices.

Adjusting the control parameters in this context means changing the setpoints of values as compared with the actual values. This may include other control modes, such as high or low setting of the level control or a sport, standard or comfort condition in the damping control or the spring control. Compensation by a second vertical control device refers in particular to a still functioning, in particular still fully functioning vertical control device. The method according to the invention is preferably performed by a control unit of a compensating device. Accordingly, the compensating device and the control unit are preferably also part of the method according to the invention.

The method according to the invention can be further developed to the extent that it is designed for controlling a vertical control system with at least two of the following vertical control devices:
Roll control of the vehicle
Air suspension of the vehicle,
Level control of the vehicle
Damping control of the vehicle

The above list is not intended to be an exhaustive list. The roll control can hereby be used to stabilize against swaying of the vehicle about the vehicle's longitudinal axis. The air suspension is used with an adjustable spring characteristic curve for the spring compression when driving over bumps. Level control refers the variation of the ground clearance of the vehicle through compression and extension of the individual spring systems. The damping control can be ensured, for example, by employing fluid valves which can provide different cross-sections for fluid passage in order to vary a compression damping or extension damping. The roll control is designed specific for each axis for a vehicle, whereas the other control systems, i.e., the air suspension, the level control and the damping control are designed specific for each wheel.

Advantageously, when a fault condition is detected with the method according to the invention in a first vertical control device embodied as a roll control, the control parameters of a second vertical control device embodied as an air suspension and/or as a damping control may be adjusted to attain a stiffer suspension or damping. If the roll control fails, there is basically a risk that the vehicle can bounce about its longitudinal vehicle axis. Bouncing causes destabilization of the driving stability of the vehicle. This can be prevented by reducing influences on the vehicle that act as a torque about the longitudinal vehicle axis. This is achieved by stiffening the damping characteristic and/or the spring characteristic. For example, the air suspension and the damping control can be set to the stiff mode or the sports mode when a fault condition has been detected in the roll control, In particular, this is performed on all four wheels of the vehicle so as to provide a symmetrical compensation.

A further advantage is achieved when a fault condition is detected with the method according to the invention in a first vertical control device embodied as an air suspension of a wheel, the control parameters of a second vertical control device embodied as an air suspension of another wheel and/or as a damping control may be adjusted to the same suspension effect and/or damping effect as in the corresponding fault condition. In other words, at least one additional wheel, preferably on the same axis, is placed in the same state as the faulty wheel. In this way, an axle compensation, but preferably a vehicle compensation can be performed on all wheels, thus preventing an asymmetry in the driving stability. The deterioration of the air suspension, for example a stiffening due to the loss of an additional volume (loss of the comfort variant) then causes all air suspension and/or all damping controls to automatically switch to a stiffer mode. In other words, a symmetrical driving stability situation is once again available for the entire vehicle.

Advantageously, when a fault condition is detected with the method according to the invention in a first vertical control device embodied as a level control, the control parameters of a second vertical control device embodied as a damping control can be adjusted to provide a stiffer damping for preventing an excessive compression of the air suspension. If the level control fails, this may be caused by a leak in the level control system or a failure of the compressor. Irrespective of the actual cause, this causes the vehicle to drop to the lowest level state. This automatically also results in a reduced immersion depth for the spring excursion in the air suspension. In order to prevent excessively deep immersion and thus the risk of damage to the air suspension under highly dynamic driving situations, the damping control is stiffened, for example placed in the sports mode. The increased damping hence prevents excessively deep immersion and commensurately the risk of damage to the air suspension.

Advantageously, when a fault condition is detected with the method according to the invention in a first vertical control device embodied as a damping control, the control parameters of a second vertical control device embodied as a level control may be adjusted to a standard level. In other words, when a control function of a fluid valve in a damping control is jammed, the level control may be adjusted to an average value, i.e. to a standard level. This is the best compromise for the driving stability in order to ensure safe onward travel.

Advantageously, when a fault condition is detected with the method according to the invention, the fault condition may be indicated to the driver as a warning signal in the vehicle. The indication may be perceptible by the driver in form of an optical, an acoustic, a tactile, or another type of signal. For example, a warning light on the display of the vehicle may indicate the fault condition. The display may preferably be specific for the respective vertical control device and/or for the respective type of fault. Advantageously, the degree of the impediment is displayed. Advantageously, the warning signal may include additional information for the driver which includes an indication of the type of compensation and the associated impairment of driving stability. In other words, after detecting the fault condition, the type of the compensation and the corresponding emergency driving situation is displayed to the driver. This further enhances the safety under continued operation of the vehicle when a fault condition is detected.

Advantageously, an intervention in the control of the vehicle that can be performed with the method according to the invention is based on the detected fault condition and the adjustment of the control parameters. Here, in addition to a possible warning signal for the driver, an active intervention in the control of the vehicle is performed. For example, the braking force may be automatically increased, the driving power may be automatically reduced or similar interventions in the vehicle control may be performed. Furthermore, the maximum possible steering angle may be varied, for example, to prevent the wheels from striking the wheel housing when the level control fails. The safety during continued operation of the vehicle after the detection of the fault condition can thereby be further enhanced.

According to another aspect of the present invention, a compensating device for controlling a vertical control system of a vehicle with at least two vertical control devices, which affect the stability of the vehicle, includes at least a control unit which is configured to monitor the operability of the at least two vertical control devices, to detect a fault condition of a first vertical control device of the at least two vertical control devices, and to adjust the control parameters of a second vertical control device of the at least two vertical control devices for at least partially compensating of the fault condition of the first vertical control device. The control unit is preferably configured for executing the method according to the invention. Accordingly, a compensating device according to the invention provides the same advantages that have been explained in detail with reference to the method according to the invention.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic overview diagram of a vertical control system.

### DETAILED DESCRIPTION OF PREFERRED EMBODIMENTS

Throughout the Figure, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

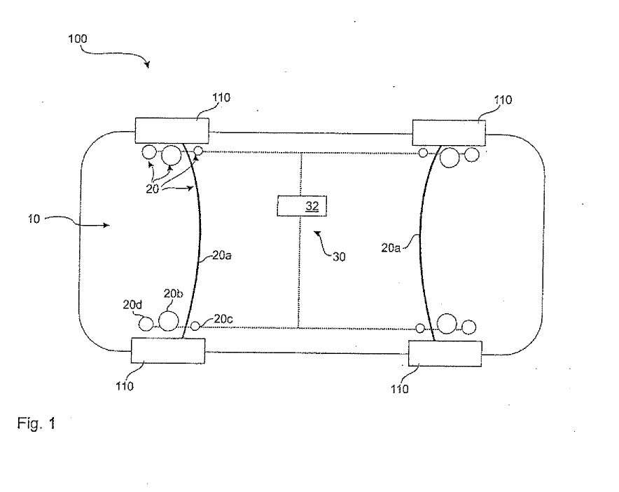

Turning now to FIG. 1, there is shown a vehicle 100 having a compensating device 30 according to the present invention. The vehicle 100 includes a vertical control system 10 with four different vertical control devices 20. A respective roll stabilization 20a is provided for the two axles, i.e. the front axle and the rear axle. This roll stabilization 20a connects the two wheels on the left and on the right with each other in order to compensate rolling of the vehicle about the vehicle's longitudinal axis.

Furthermore, an air suspension 20b, a level control 20c and a damping control 20d are arranged on each wheel 110. Although these vertical control devices 20 are shown here separately from each other, they may of course also be combined in a single component, e.g. used as a spring-damper combination.

In the embodiment illustrated in FIG. 1, the compensating device 30 includes a control unit 32 which is connected for signal communication with all the vertical control devices 20 of the vertical control system 10. The fault conditions of the individual vertical control devices 20 can thereby be detected and forwarded to the control unit 32. The control parameters and setpoints of the still intact and still functioning additional vertical control devices can then be changed and adapted based on detected fault conditions. The purpose of this adjustment is at least partially compensation of this fault condition with the invention so as to ensure that the vehicle can continue driving at least to the next garage.

The foregoing explanation of the embodiments describes the present invention exclusively within the context of examples. It will be understood that individual features of the embodiments can be combined with one another, if technically feasible, without departing from the scope of the present invention.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for controlling a vertical control system of a vehicle with at least two vertical control devices that influence driving stability of the vehicle, the method comprising:
monitoring functionality of the at least two vertical control devices by using sensor devices of a respective control unit of the vertical control devices,
detecting a fault condition of a first vertical control device of the at least two vertical control devices, and
adjusting control parameters of at least one second vertical control device of the at least two vertical control devices so as to at least partially compensate the fault condition of the first vertical control device.

2. The method of claim 1, wherein the vertical control system comprises at least two of the following vertical control devices:
a roll control,
an air suspension,
a level control, and
a damping control.

3. The method of claim 2, wherein the first vertical control device is embodied as the roll control and the second vertical control device is embodied as at least one of the air suspension and the damping control, wherein upon detection of the fault condition of the first vertical control device the control parameters of the second vertical control device are adjusted to achieve a stiffer suspension or damping.

4. The method of claim 2, wherein the first vertical control device is embodied as the air suspension of a wheel and the second vertical control device is embodied as at least one of the air suspension of another wheel and the damping control, wherein upon detection of the fault condition of the first vertical control device the control parameters of the second vertical control unit are adjusted to provide an identical suspension effect or damping effect commensurate with the fault condition.

5. The method of claim 2, wherein the first vertical control device is embodied as the level control and the second vertical control device is embodied as the damping control, wherein upon detection of the fault condition of the first vertical control device the control parameters of the second vertical control device are adjusted to provide a stiffer damping so as to avoid to an excessively deep immersion of the air suspension.

6. The method of claim 2, wherein the first vertical control device is embodied as the damping control and the second vertical control device is embodied as the level control, wherein upon detection of the fault condition of the first vertical control device the control parameters of the second vertical control unit are adjusted to a standard level.

7. The method of claim 1, further comprising displaying the fault condition to a driver of the vehicle as a warning signal after detection of the fault condition.

8. The method of claim 1, wherein an intervention in control of the vehicle is performed based on the detected fault condition and the adjusted the control parameters.

9. A compensating device for controlling a vertical control system of a vehicle with at least two vertical control devices that influence driving stability of the vehicle, the compensating device comprising:
at least one control unit which is configured to
monitor functionality of the at least two vertical control devices,
detect a fault condition of a first vertical control device of the at least two vertical control devices, and
adjust control parameters of a second vertical control device of the at least two vertical control devices so as to at least partially compensate the fault condition of the first vertical control device.
